(19) United States
(12) Patent Application Publication
(10) Pub. No.: US 2006/0249442 A1
(43) Pub. Date: Nov. 9, 2006

(54) Water filtration system with improved performance

(76) Inventors: Walter N. Yap, Boca Raton, FL (US); Paul Lincoln, Weston, FL (US); Keith C. Bernard, West Hollywood, FL (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/394,966

(22) Filed: Mar. 31, 2006

Related U.S. Application Data
(60) Provisional application No. 60/667,728, filed on Apr. 1, 2005.

(51) Int. Cl. B01D 35/00; B67D 5/58

(52) U.S. Cl. 210/470; 210/474; 222/189.06

(57) ABSTRACT

A portable water container includes a body defining a reservoir, a replaceable filter housed in a storage compartment of the body, and a connection assembly. The assembly connects a water supply source to the filter. Pressurized water from the water supply source flows under pressure through the filter and into the water reservoir through an outlet port in the storage compartment. The body is configured to store the connection assembly when not connecting the water faucet to the filter.

### BACKGROUND OF THE INVENTION

1. Field of the Invention

The present invention relates to improved water filtration systems and, more particularly, to a filtered water pitcher system with improved performance.

2. Brief Description of Prior Developments

The use of filtered water pitchers to purify drinking water is well known in the art. However, most conventional water pitchers on the market today use carbon granule filters and/or filters that are gravity fed. In addition, these filters usually require pre-soaking or wetting before use, are slow and do not remove as many contaminants due to the relatively large particle sizes.

Other drinking water purification devices have sought to rectify the above drawbacks, such as described in U.S. Pat. No. 5,454,944 (“the '944 patent”), U.S. Pat. No. 5,290,442 (“the '442 patent”), U.S. Pat. No. 5,560,393 (“the '393 patent), U.S. Pat. No. 5,976,362 (“the '362 patent”) and U.S. Pat. No. 6,123,837 (“the '837 patent”). Specifically, U.S. Pat. Nos. 5,454,944, 5,290,442, 5,560,393 relate to devices and methods for providing purified or specially treated drinking water from relatively less pure tap water sources. More particularly, the '944, '442 and '393 patents relate to portable self-contained water treatment and jug storage apparatus including a refrigerator storage jug having water treating and connector elements mounted thereon which may be placed on a countertop adjacent a household sink to be filled/refilled with purified drinking water and thereafter the jug may be disconnected and placed in a refrigerator to dispense chilled drinking water in use. Next, U.S. Pat. Nos. 5,976,362 and 6,123,837 relate to a faucet mounted water filter having a replaceable filter cartridge assembly.

Despite the above advances, there is still a strong need in the art, however, for a simple, easily manufacturable method of implementing an improved filtered water pitcher which provides filtered tap water to the user faster and which removes a greater amount of harmful contaminants during the process than typical granular and gravity fed filters. There is also a need in the art for a compact water filtration system, wherein essentially all of the parts/elements of the system may be stored together as a single unit when filtration is not taking place.

The present invention accomplishes the above needs in the art and also provides other advantages, as will be described in detail below.

### BRIEF DESCRIPTION OF THE DRAWINGS

FIG. 1 is a side view of a water filtration system 10 embodiment of the present invention;

FIGS. 2a-2c illustrate an example of a manifold which may be used in accordance with the present invention;

FIG. 3 depicts a shroud feature for housing the filter itself or manifold containing the filter within the pitcher;

FIG. 4 is a side view of a water filtration system 110 embodiment of the present invention, wherein the hose element of the connecting assembly is axially movable inward and outward through a side opening in the handle of the pitcher;

FIG. 5 is a side view of a water filtration system 210 embodiment of the present invention, wherein the hose element is a coiled helical pressure hose housed in a chamber adjacent to the storage compartment within the pitcher;

FIGS. 6-8 are side views of a water filtration system 310 embodiment of the present invention, wherein a majority of the hose element is stored, in between filtration uses, on the exterior of the pitcher within a groove on the handle of the pitcher; and

FIG. 9 is a side view of a water filtration system 410 embodiment of the present invention, wherein the carbon block filter is housed within the water reservoir of the pitcher without a manifold.

### SUMMARY OF THE INVENTION

In accordance with an aspect of the invention, a portable water container is provided. The portable water container comprises a frame having a water reservoir and a replaceable filter connected to the frame. The water container further comprises a connection assembly adapted to connect a pressurized water supply source from a water tap under pressure to the filter, wherein water from the water tap is adapted to flow under pressure through the filter and into the water reservoir.

### DETAILED DESCRIPTION OF THE PREFERRED EMBODIMENTS

In one aspect, devices and methods for providing improved water filtration of tap water are disclosed. In one embodiment, a disclosed water filtration system connects a kitchen faucet or other pressurized water supply source to a carbon block filter housed within a water pitcher or container. The operable connection between the faucet and the filter is preferably implemented as a flexible rubber pressure hose and quick connectors and adapters that affix one end of the hose to the faucet and wherein the other end of the hose leads to the filter. However, the faucet can also be connected to the carbon block filter in the pitcher directly without using a hose.

The tap water is supplied under pressure in the range of approximately 20 to 80 pounds per square inch (PSI) by the faucet through a hose to the filter and forced through the filter under pressure resulting in a more efficient and expedient filtration process than is achievable by gravity feed filters or granular filters typically used in conventional water pitcher filtration systems. The above described benefits provide the user shorter wait time for receiving his or her water. Moreover, the use of a carbon block filter as part of the filtration system provides a greater level of contaminant and impurity removal than is achieved by typical granular filters used in conjunction with conventional water pitchers.

In addition, in certain aspects, the connection apparatus (e.g., hose and quick connector) may be stored in different locations of the water pitcher. This feature allows the user to keep essentially all of the elements/parts of the filtration system together as a single unit, thereby significantly reducing the risk that any of the parts of the filtration system will become lost when the system is not in use. For example, in one aspect, the hose and connector attachment may be housed within a storage compartment of the pitcher. Also, in other aspects of the invention, the hose and quick connector attachment may be stored on the outside of the water pitcher within a groove of the pitcher's handle. The storage of the hose on the outside handle of the pitcher also provides the additional advantage of having more compartmental space for water storage within the pitcher, since the hose is now housed on the outside.

Different embodiments of a system for achieving the improved tap water filtration will be discussed in greater detail below.

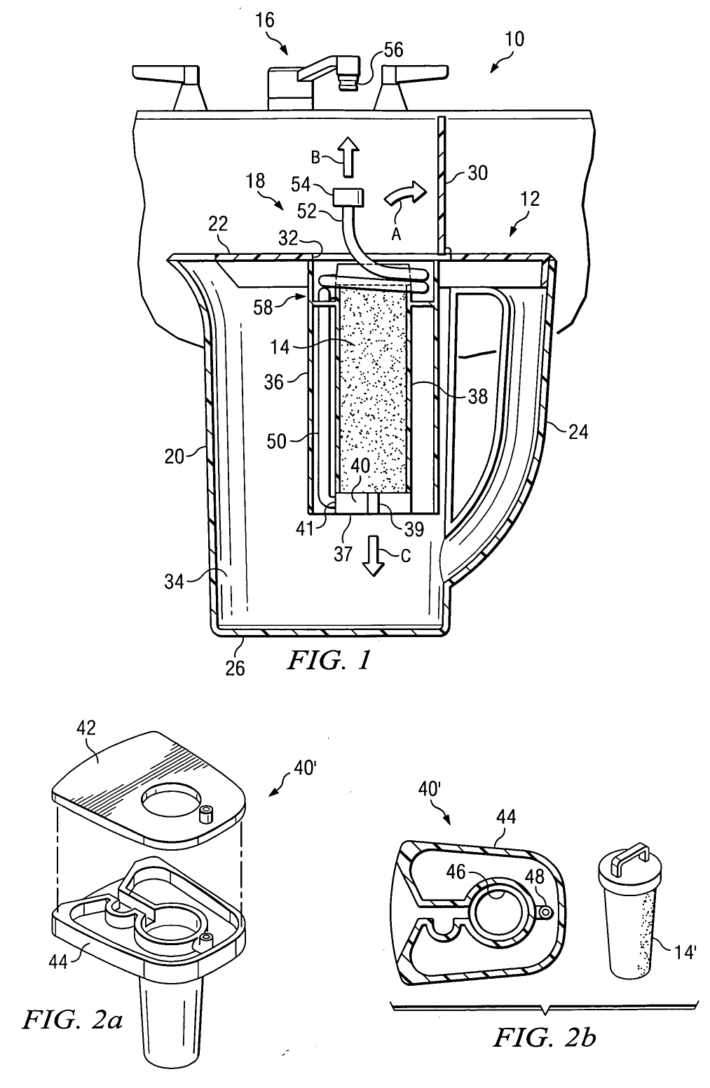

For example, referring to FIG. 1, there is shown a side view of a water filtration system 10. Although system 10 will be described with reference to the exemplary embodiment shown in the drawings, it should be understood that system 10 can be embodied in many alternate forms of embodiments. In addition, any suitable size, shape or type of elements or materials could be used.

Water filtration system 10 according to the embodiment depicted in FIG. 1 includes a water pitcher 12 for receiving and dispensing filtered water, a filter 14, preferably a replaceable, carbon block filter, and a connecting assembly 18 for connecting carbon block filter 14 to a pressurized water supply source 16. Although the water filtration system embodiments discussed herein relate to water pitchers, the present invention is not limited thereto but rather may be used in conjunction with any other type of container, device or apparatus known in the art of water filtration.

Referring back to the embodiment depicted in FIG. 1, pitcher 12 is preferably injection molded from a suitable plastic, such as polypropylene. Pitcher 12 may be of varying sizes, dimensions, and shapes. Further, pitcher 12 preferably includes a body portion 20, a removable top cover or lid 22 defining an upper portion of pitcher 12, a handle 24 integral with body 20 of pitcher 12, and a pour spout. Body 20 of pitcher 12 has a sealed, bottom base 26 and an open ended top portion. The top portion of body 20 is covered by removable cover 22. However, in alternative embodiments, cover 22 could be designed to be formed integrally with the top portion of pitcher 12.

Moreover, cover 22 of pitcher 12 might also be provided with a section or flap 30 which may be opened to create an opening 32 within top cover 22, thereby allowing the user to operatively connect pressurized water supply source 16 to filter 14 housed within a storage compartment 36 connected to the body of pitcher 12 through opening 32. For example, in the embodiment depicted in FIG. 1, flap 30 of top cover 22 is a hinged flap which is movable upwards (as shown by arrow A) for creating the opening for accessing the interior of pitcher 12 and movable downwards for closing opening 32 in cover 22 when filtration is complete. In alternative embodiments, different configurations (e.g. sliding, shifting or completely removing a portion of the cover) apparent to those skilled in the art could also be used for creating an opening in top cover 22 for accessing the interior of pitcher 12. Also, in alternative embodiments as will be discussed in further detail below, filter 14 could instead be operatively connected to water supply source 16 through an opening in the side of pitcher 12 (FIG. 4) or through other locations on pitcher 12 as well.

Referring back to FIG. 1, within body 20 of pitcher 12 is a water reservoir 34 for storing the filtered water and also a filter storage compartment 36. As shown in FIG. 1, storage compartment 36 is made of side walls, a base 37, as well as an open top end which is covered by top cover 22 of pitcher 12. Storage compartment 36 is separated within the body of pitcher 12 from water reservoir 34, but in fluid communication therewith, via a filtered water outlet port 39 located within base 37 of storage compartment 36. Storage compartment 36 may be formed integrally with pitcher 12 or attached as a separate piece. However, in alternative embodiments, no separate housing compartment for the carbon block filter is provided, but rather, filter 14 is instead housed within water reservoir 34.

In some embodiments, filter 14 is a replaceable, carbon block filter, as shown in FIG. 1. In these embodiments, filter 14 may be any conventional carbon block filter known in the art. Other types of filter media known in the water purification art, e.g., granular activated carbon filters, may also be used in accordance with the present invention. However, the use of certain filtration media such as granular filters is not recommended, due to the significant advantages and benefits provided by carbon block filters over these other types of filters.

In particular, besides removing the typical impurities such as chlorine and lead found in tap/drinking water, carbon block filters also effectively remove many contaminants found in tap water that typical granular filters used in water pitcher filtration art do not remove. A list of contaminants which carbon block filters remove but granular filters do not remove include but are not limited to 2, 4-D, alachor, atrazine, carbofuran, chlordane, endrin, carbon tetrachloride, heptachlor epoxide, lindane, Methoxyxhlor, benzene, ethylbenzene, chlorobenzen, o-dichlorbenzene, simazene, styrene, toxaphene, tetrachloroethylene, toluene, trichloroethylene, TTHM (total trihalomenes), VOC, asbestos, cryptosporidium, giardia, and sediment.

Filter 14 of this embodiment is contained within an outer shell or casing 38 and located within storage compartment 36 of pitcher 12. Moreover, in FIG. 1, at least a portion of filter 14 within outer shell casing 38 is further contained/housed within a water guidance assembly or manifold 40, as will be described in detail below. Further, manifold 40 and filter 14 housed therein are positioned within storage compartment 36 such that water reservoir 34 receives filtered water exiting filter 14 via water outlet port 39 in base 37 of storage compartment 36.

As mentioned above, water filtration system 10 as depicted in FIG. 1 includes a water guidance assembly or manifold 40. Manifold 40 directs the flow of supplied tap water received through water inlet port 41 of manifold 40 into and out of filter 14. In this embodiment, manifold 40 houses at least a portion of filter 14 with outer shell casing 38 therein. While the embodiment depicted in FIG. 1 illustrates filter 14 positioned above manifold 40, other embodiments may position filter 14 adjacent to or below manifold 40. Manifold 40 (i) directs the flow of supplied tap water to the proper place within filter 14 for filtration and (ii) directs the flow of water which has already been filtered directly into either water reservoir 34 or, instead, redirects the filtered water flow to another location within manifold 40 and then ultimately into water reservoir 34. As shown in FIG. 1, manifold 40 with filter 14 contained therein is housed within storage compartment 36 separate from water reservoir 34. In alternative embodiments, manifold 40 with filter 14 contained therein is housed within water reservoir 34, instead of in a separate storage compartment 36.

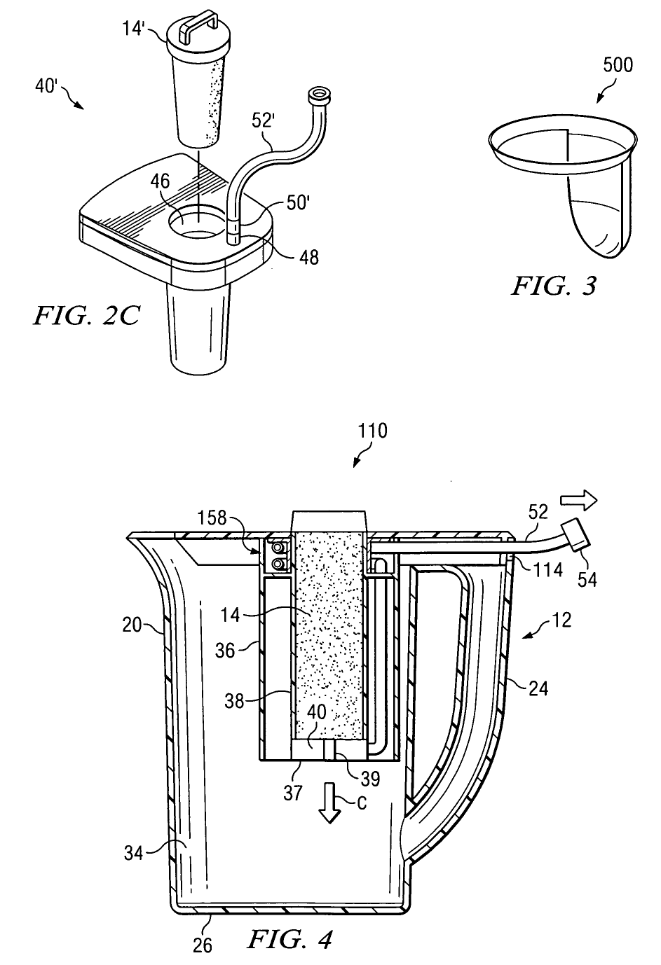

A specific illustrative example of a manifold 40′ is depicted in FIGS. 2a-2c. As best shown in FIG. 2a, the depicted embodiment of manifold 40′ comprises a top section 42 and a bottom section 44 connected or molded together. Top section 42 of manifold 40′ contains an opening 46 therein for housing at least a portion of carbon block filter 14 therein. Manifold 40′ also includes a water port or orifice 48 for receiving connecting elements (e.g., a water line tube 50 and a hose 52) for operatively connecting carbon block filter 14 to a pressurized supply source (e.g., a faucet). The design configurations (e.g., chambers, channels, contours) within manifold 40′ as shown in the cross-section view of FIG. 2b are what determine how the flow of supplied tap water entering manifold 40′ will be directed within manifold 40′ and filter 14. It is noted that water port 48 of manifold 40′ illustrated in FIG. 2a, differs from the water port 41 of the manifold 40 of FIG. 1. For example, water port 41 as depicted in FIG. 1 is located on the bottom portion of manifold 40, whereas in FIG. 2, port 48 is located on top portion 42 of manifold 40′.

Referring back to the embodiment of FIG. 1, pressurized water supply 16 (e.g., kitchen faucet) is operatively connected to carbon block filter 14 housed within manifold 40 via connecting assembly 18. As shown in FIG. 1, connecting assembly 18 comprises a water line tube 50, a connecting means such as a rubber hose 52, a quick connector 54, and a quick connector adapter 56. Water line tube 50 of connecting assembly 18 is preferably comprised of plastic and located within water inlet port 41 of manifold 40, with a top portion of tube 50 protruding out of port 41. Hose 52 of connecting assembly 18 has a top open end and a bottom open end. The bottom open end of hose 52 connects to top end of water line tube 50 which is located partially within water inlet port 41 of manifold 40. Attached to the top open end of hose 52 is quick connector 54 which also connects to quick connector adapter 56, thereby establishing an operative connection between pressurized water supply source 16 and carbon block filter 14 via hose 52.

When filtration is not taking place, as shown in FIG. 1, hose 52 and quick connector 54 attachment are stored within storage compartment 36 within body 20 of pitcher 12. During storage, hose 52 is preferably coiled or wound around the top portion of filter 14 within storage compartment 36. Further, as shown in FIG. 1, a positioning means, such as a plastic reel assembly 58, is also provided within the storage compartment 36 of pitcher 12 in operable relation to manifold 40, in order to facilitate storage of hose 52 around the top portion of filter 14. Plastic reel assembly 58 also facilitates the pulling or withdrawal of the top end of hose 52 with quick connector 54 attachment out from pitcher 12 for connection to pressurized water supply source 16.

As previously mentioned, in alternative embodiments of the invention, hose 52 and quick connector 54 elements of connecting assembly 18 may instead be housed, in between filtrations, in other locations of pitcher 12 besides those described above. For instance, hose 52 and quick connector 54 may be stored on the exterior of pitcher 12 within outer grooves of handle 24. The above alternative embodiment, as well as others will be described in further detail below.

Now again referring back to FIG. 1, the pressurized water supply source 16 is preferably a faucet (e.g., kitchen or bathroom faucet). As discussed, water supply source 16 supplies tap water under pressure to carbon block filter 14 within pitcher 12 of filtration system 10, via the connecting assembly 18 (e.g., hose 52, quick connector 54, quick connect adapter 56 and water line tube 50). A suitable water pressure is in the range of approximately 20 to 80 PSI. By using a pressurized water supply source 16, such as a faucet, the tap water is forced through filter 14 under pressure (greater flow rate) resulting in a more efficient and expedient filtration process than achieved by gravity feed type filter systems. Other devices apparent to those skilled in the art, besides a kitchen or bathroom faucet may also be used in accordance with the present invention for achieving the pressurized water supply flow described above. One such possible example could be a separate pumping device.

In using the filtration system embodiment 10 of FIG. 1 to filter tap water, first a user would operatively connect pressurized water supply source 16 (herein as referred to in this embodiment as the kitchen faucet) to carbon block filter 14 housed partially within manifold 40. In order to make the above connection, the user would pull a portion of hose 52, which includes the top end having quick connector 54 affixed thereto, through opening 32 in top cover 22 and connect quick connector 54 to quick connect adapter 56, which is already affixed to water supply source 16 as shown in FIG. 1. At this point, the bottom end of hose 52 is already connected to the top end of water line tube 50 which is located within water port 41 of manifold 40, so that, once hose 52 and pressurized water supply source 16 are connected to one another, in the manner described above, an operative connection between the carbon block filter and the kitchen faucet is established.

Next, pressurized water supply source 16 would then be turned on thereby causing tap water to flow under pressure through hose 52 and into manifold 40 through water line tube 50 contained within water port 41 and then from within manifold 40, the supplied tap water is directed by the design configuration of manifold 40 directly into carbon block filter 14 for filtration. Once the tap water has been filtered by filter 14, this filtered water is ultimately directed by manifold 40 into water reservoir 34 through outlet 39 in base 37 of the storage compartment 36 (as shown by arrow C) for storage and/or immediate dispensing for drinking. The user ideally keeps the faucet running until water reservoir 34 has become full with filtered water or otherwise filled to a desired level of his or her preference. As discussed throughout, filtration system 10 preferably produces filtered water more rapidly and with far fewer contaminants, impurities, etc. than filtered water produced by conventional water pitcher filtration devices.

Now, once filtration has been completed (e.g., the desired filtered water level is reached in water reservoir 34 of pitcher 12), the user then disconnects hose 52 from pressurized water supply source 16 by detaching quick connector 54 from adapter 56 on pressurized water supply source 16. The user would then place hose 52 with quick connector 54 attachment back into compartment 36 of pitcher 12 for storage and close flap 30 of the top cover 22. Next, the user either, for example, places pitcher 12 into the refrigerator for later use or alternatively dispenses some or all of the filtered water from reservoir 34 for drinking, cooking or other purpose. The above described method is meant for illustrative purposes only and is in no way meant to limit the scope of practicing the invention.

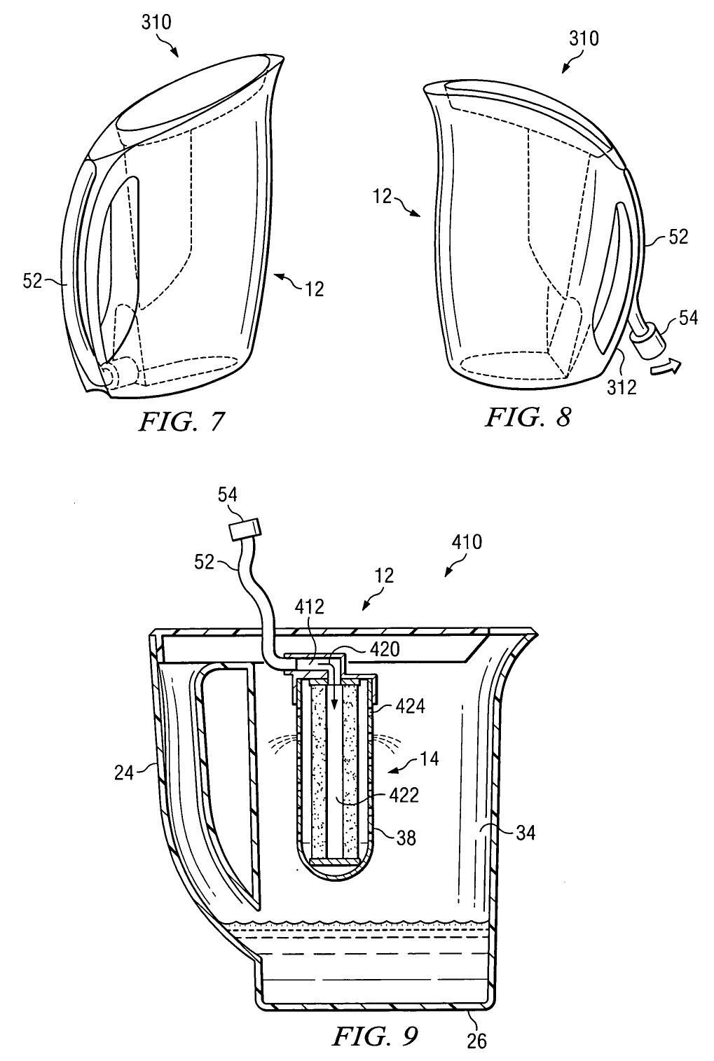

In alternative embodiments of the invention, hose 52 and quick connector 54 are housed and/or placed differently, in relation to water pitcher 12, than the implementation depicted in FIG. 1. Some of these alternative embodiments are illustrated in FIGS. 4-8 and discussed below. One distinction between these alternative embodiments and the embodiment of FIG. 1 is with regard to the storage and/or placement of hose 52 in relation to pitcher 12 of the filtration system.

For instance, filtration system 110 embodiment depicted in FIG. 4 includes a hose 52 that, in this embodiment, is axially movable/slidable inward and outward through a side opening or portal 114 in handle 24 of pitcher 12. During storage, as shown in FIG. 4, hose 52 is preferably coiled or wound around the top portion of filter 14 within storage compartment 36, via a reel mechanism 158 provided within storage compartment 36 of pitcher 12 in operable relation to manifold 40. Reel mechanism 158 could, for example, be stationary, movable or spring loaded. Moreover, when filtration is desired, the end of hose 52 having the quick connector 54 attachment is pulled outward from storage in storage compartment 36 of body 20 of pitcher 12 for connection to pressurized water supply source 16. When filtration is completed, quick connector 54 is disconnected from quick connect adapter 56 and hose 52 with quick connector 54 attachment is slid back inward or snaps back inward automatically when released (e.g., when a spring loaded reel mechanism 158 is used) into storage compartment 36 through side portal 114 of handle 24.

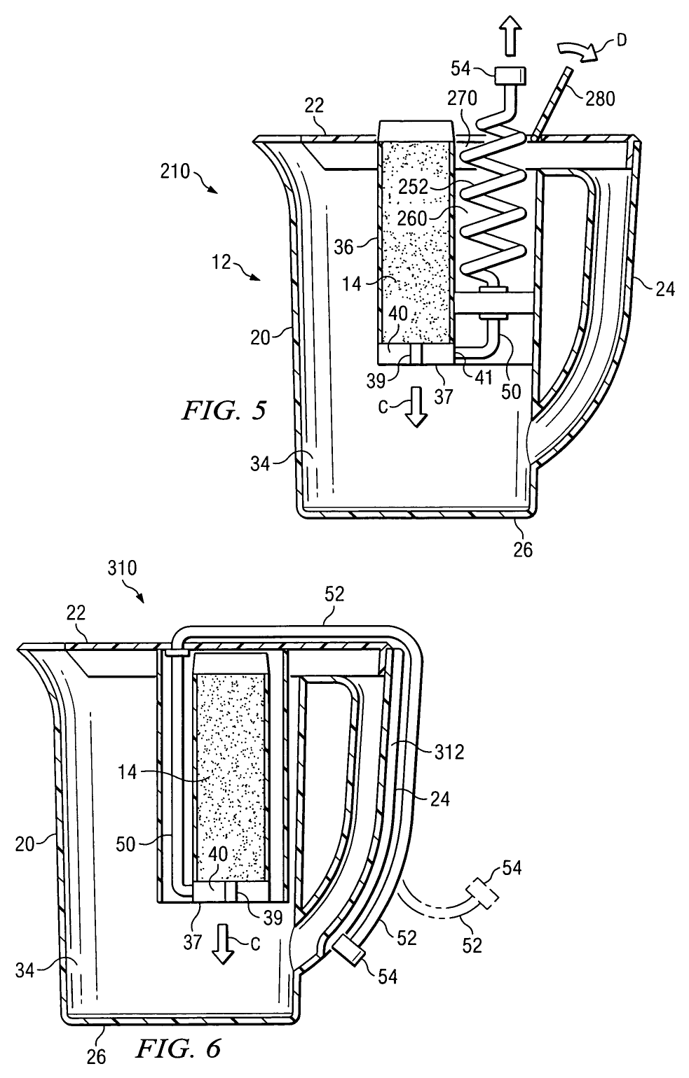

Further, a water filtration system 210 embodiment depicted in FIG. 5, hose 252 in the embodiment of FIG. 5 is helically coiled. Also in FIG. 5, hose 252 is not housed within storage compartment 36 of pitcher 12, but rather is housed within a chamber 260 adjacent to storage compartment 36. As with the embodiment of FIG. 1, the bottom end of hose 252 connects to water line tube 50 housed in water inlet port 41 of manifold 40. By way of illustration, when filtration is desired using this embodiment, the end of hose 252 having quick connector 54 attachment is pulled outward from chamber 260 of pitcher 12 through an opening 270 in top cover 22 created by lifting of a flap 280 upwards (as shown by arrow D in FIG. 5). Hose 252 is then connected to a pressurized water supply source 16 in the same manner as described for the embodiment of FIG. 1. When filtration is complete, hose 252 with quick connector 54 attachment snaps or springs back into place within chamber 260 of pitcher 12 due to the helical nature of hose 252.

Now turning to water filtration system 310 of FIGS. 6-8, in this embodiment a majority of hose 52, including quick connector 54, is stored on the exterior of pitcher 12 on integral handle 24. Specifically, as can be see in FIGS. 6-8, in between filtration uses, a majority of hose 52, including quick connector 54 attachment, snaps or locks into a groove 312 on integral handle 24 of pitcher 12. By way of illustration, when filtration is desired using this embodiment, the end of hose 52 having quick connector 54 is pulled upward as best shown in FIG. 8 to release the portions of hose 52 from engagement within handle 24, thus enabling hose 52 to be connected to a pressurized water supply source 16. When filtration is complete, hose 52 with quick connector 54 is snapped back into place within groove 312 of pitcher handle 24.

In still other embodiments of the present invention, no manifold is provided with the water filtration system. Rather, in some of these embodiments, the filter is contained within the outer shell and housed within either the storage compartment or water reservoir 34 of the pitcher with no manifold. In other of these embodiments, the filter may be left partially or entirely exposed (without any outer casing or only a partial outer casing) and housed within either the water reservoir or the storage compartment of the pitcher.

By way of example, FIG. 9 illustrates a water filtration system 410 wherein carbon block filter 14 is housed within an outer casing 38, but without a manifold. Moreover, in this embodiment, filter 14 with outer casing 38 is housed within water reservoir 34 of water pitcher 12. Moreover, one end of hose 52 attaches to a water inlet port 412 at the top of filter 14 and the other end of the hose has a quick connector 54 affixed thereto for connecting hose 52 to a faucet in the same manner as discussed in the previous embodiments. Further, as can be seen in FIG. 9, the pressurized water (represented by arrow 420) supplied by the faucet, flows through water inlet port 412 at the top of filter 14 and travels down within open space 422 of cyclindrically shaped carbon block filter 14 and then out of filter 14 through slits 424 provided in a side of outer casing 38 of filter 14. These slits 424 provided in the side of outer casing 38 allow the filtered water to cascade out from these slits 424 in a waterfall like fashion into water reservoir 34, thereby creating an aesthetic pleasing water filtration process. In this regard, the sides of pitcher 12 of this embodiment are preferably transparent or have a viewing window through which the waterfall like effect can be seen.

In yet other embodiments for the water filtration systems of the invention, the filter could instead be attached directly to a faucet without the use of a hose. However, the use of a hose for making the connection between filter and faucet is recommended due to the flexibility the hose provides.

Additional features may also be provided with any of the water filtration system embodiments previously mentioned herein. These additional features include a method and device for incorporating certain additives into the filtered water stored in the water reservoir of the pitcher. These additives include but are not limited to flavorings (e.g., powdered tea mix for making iced tea), vitamins, minerals, etc.

For cosmetic purposes, the carbon block filter itself or the manifold containing the filter therein may be housed within a shroud 500 element or feature within the pitcher. (See FIG. 3).

Still other features which may be added to the water filtration system configurations of the present invention include a filter change indicator for informing the user when the end of the life of the filter has been reached. The filter change indicator can, for example, be based upon time, volume or pressure. For instance, a flow meter or sensor could be used to count the volume of water entering the filter for determining when it is time to change the filter. However, any method or device known in the art for indicating the end of life of a water filter may be used in accordance with the present invention.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A portable water container comprising:
a body defining a reservoir;
a replaceable filter housed in a storage compartment of the body; and
a connection assembly adapted to connect a water faucet, operable to produce pressurized water, to said filter, wherein pressurized water from the water faucet is adapted to flow under pressure through the filter and into the water reservoir through an outlet port in the storage compartment;
wherein the body is configured to store the connection assembly when not connecting the water faucet to the filter.

2. A fluid pitcher, comprising:
a body defining a reservoir and including a storage compartment;
a fluid filter housed at least partially within the storage compartment; and
a manifold to direct a flow of pressurized fluid to the fluid filter to create filtered fluid and to direct the filtered fluid into the reservoir through an outlet of the manifold.

3. The pitcher of claim 2, further comprising connecting elements connected between a fluid port of the manifold and a source of the pressurized fluid.

4. The pitcher of claim 3, wherein the connecting elements include a hose.

5. The pitcher of claim 4, further comprising a storage compartment within the reservoir, wherein the filter is at least partially contained within the storage compartment.

6. The pitcher of claim 5, wherein the storage compartment is further configured to contain the hose when the hose is not connected to the source of pressurized fluid.

7. The pitcher of claim 6, further comprising a pitcher top including a hinged lid portion, wherein the hinged lid portion provides access to an interior of the storage compartment.

8. The pitcher of claim 5, further comprising a chamber adjacent to the storage compartment and adapted to contain the hose when the hose is not connected to the source of pressurized fluid.

9. The pitcher of claim 5, wherein the hose is a helical hose.

10. The pitcher of claim 3, wherein a majority of the hose is stored, when not connected to the source of pressurized fluid, on an exterior of the pitcher within a groove on a pitcher handle.

11. The pitcher of claim 3, wherein the source of pressurized fluid comprises a faucet operable to produce water having a pressure in the range of approximately 20 to 80 PSI.

12. The pitcher of claim 11, wherein the filter comprises a carbon block filter.

13. A water pitcher, comprising:
a body including a base, the body defining a reservoir;
a replaceable water filter housed in a storage compartment having an outlet port at least partially overlying the base; and
a connection assembly to connect a source of tap water and the water filter to force, under pressure, tap water through the water filter before entering the reservoir.

14. The pitcher of claim 13, wherein the connection assembly includes a manifold to direct a flow of tap water.

15. The pitcher of claim 14, wherein the connecting assembly includes a flexible rubber hose.

16. The pitcher of claim 13, wherein the storage compartment is further configured to contain the hose when the hose is not connected to the source of pressurized fluid.

17. The pitcher of claim 16, further comprising a pitcher top including a hinged lid portion, wherein the hinged lid portion provides access to an interior of the storage compartment.

18. The pitcher of claim 13, further comprising a chamber adjacent to the storage compartment and adapted to contain the hose when the hose is not connected to the source of pressurized fluid.

19. The pitcher of claim 18, wherein the hose is a helical hose.

20. The pitcher of claim 13, wherein the source of pressurized fluid comprises a faucet operable to produce water having a pressure in the range of approximately 20 to 80 PSI.
